(19) United States
(12) Patent Application Publication
(10) Pub. No.: US 2016/0008736 A1
(43) Pub. Date: Jan. 14, 2016

(54) PROCESSING DEVICE AND PROCESSING METHOD

(71) Applicant: KABUSHIKI KAISHA KOBE SEIKO SHO (KOBE STEEl, LTD.), Kobe-shi (JP)

(72) Inventors: Akira MATSUOKA, Kobe-shi (JP); Koji NOISHIKI, Takasago-shi (JP)

(73) Assignee: Kabushiki Kaisha Seiko Sho (Kobe Steel, Ltd.), Kobe-shi (JP)

(21) Appl. No.: 14/771,067

(22) PCT Filed: Apr. 9, 2014
(86) PCT No.: PCT/JP14/02038

§ 371 Date: Aug. 27, 2015

(30) Foreign Application Priority Data
Apr. 22, 2013 (JP) 2013-089304

(51) Int. Cl. B01D 11/04

(52) U.S. Cl. CPC B01D 11/0453

(57) ABSTRACT

Provided are a processing device (1) and a processing method that enable an efficient chemical operation by means of reducing the time for separating into individual starting material fluids a mixture of starting material fluids that had once been fractionated. The processing device (1) is provided with: a separation tank (5) that contacts together a first and second starting material fluid (2a, 2b) that differ in specific gravity, performing a chemical operation at the portion at which both starting material fluids contact, and houses the first and second starting material fluids (2a, 2b) that are separated vertically; and a flow path forming member (6) that is disposed within the separation tank (5) and forms a plurality of minute ducts (7) for causing the upper starting material fluid (2a) layer to contact the lower starting material fluid (2b) layer. Each minute duct (7) is provided with: a first duct (9) that penetrates the flow path forming member (6) in the vertical direction and guides the second starting material fluid (2b) below the flow path forming member (6) to above the flow path forming member (6); and a second duct (10) that connects to the first duct (9) in a manner so as to introduce the upper first starting fluid (2a) layer into the first duct (9).

### TECHNICAL FIELD

The present invention relates to a processing device and a processing method for performing a chemical operation such as extraction, separation and reaction between a first and a second starting material fluids by contacting together the first and the second starting material fluids which differ in specific gravity.

### BACKGROUND ART

In general, in a case of a synthesis of an organic compound, a component of object of extraction in a solvent is extracted by using a “liquid-liquid extraction operation” after the synthesis. This “liquid-liquid extraction operation” intends, for example, to mix together solvents which are not soluble with each other, and transfer a substance of object of extraction from one solvent toward the other solvent. In this liquid-liquid extraction operation, an extraction device of so-called mixer-settler type is used.

For example, non-patent document 1 discloses an extraction device of a representative mixer-settler type. This extraction device comprises a mixer tank having a stirring blade which houses a solution of starting material and stirs the solution, and a settler tank in which the starting material fluid which has been stirred and separated in the mixer tank is left standing to be separated again. Specifically, the mixer tank fractionates a light liquid and a heavy liquid together into fine droplets by stirring so that contact areas of the light liquid and the heavy liquid is increased by the fractionation, to allow the operation such as extraction or separation to be performed in a short time.

Incidentally, in order to further increase the extraction speed in the above-described extraction device of mixer-settler type, it is preferred to increase the rotational speed of the stirring blade in the mixer tank and further vigorously stir the starting material fluids to promote the fractionation of the light liquid and the heavy liquid. In such a manner, the contact area between the light liquid and the heavy liquid becomes larger to further accelerate the movement of the substance of object of extraction from one starting material fluid toward the other starting material fluid, and the extraction speed is considered to be improved.

However, when the fractionation of the light liquid and the heavy liquid progresses excessively by an excessive stirring, the light liquid and the heavy liquid break into so minute droplets that it take extra time in separating the starting material fluids (raw liquid) after extraction into two single materials again in the settler tank, causing a high possibility that workability of the separation becomes extremely poor. That is, in the above-described extraction device, even if a stirring is made excessively strong, the time an extraction takes is not shortened very much in total. Thus, improvement in productivity is naturally limited.

In the above-described extraction device, the chemical operation performed through the liquid-liquid boundary surface is an extraction. However, a similar problem occurs also in a case of performing a chemical reaction on the liquid-liquid interface.

### CITATION LIST

### Non-Patent Document

Non-patent document 1: Hiroshi AIHARA, “The Story of Chemistry You Want to Know ‘Technique of Separation’ ” Japan Industrial Journal, Jun. 28, 2008, the first printing of the first edition, p. 100-101

### SUMMARY OF THE INVENTION

The present invention has a purpose of providing a processing device and a processing method which are capable of enhancing an efficiency in a case of performing a chemical operation such as extraction, separation or reaction, by transferring a substance through a boundary surface where a first and a second starting material fluids which differ in specific gravity contact with each other.

The present invention provides a processing device which contacts a first and a second starting material fluids which differ in specific gravity together, to perform a chemical operation in a part where the first and the second starting material fluids contact with each other. This processing device comprises a separation tank which accommodates the first starting material fluid and the second starting material fluid in a state separated into an upper layer and an lower layer respectively, and a flow path forming member that is disposed inside the separation tank and forms plural minute flow paths for contacting the first starting material fluid in an upper layer with the second starting material fluid in a lower layer of the separation tank. Each of the plural minute flow paths comprises a first flow path that penetrates the flow path forming member in an up/down direction and guides the second starting material fluid of the lower side of the flow path forming member toward the upper side of the flow path forming member; and a second flow path that connects to the first flow path so as to take in the first starting material fluid of the upper layer and introduce the fluid into the first flow path.

The present invention also provides a processing method which contacts the first starting material fluid and the second starting material fluid which differ in specific gravity to thereby perform a chemical process in the part where these first and second starting material fluids contact with each other. This processing method comprises preparing a separation tank which accommodates the first starting material fluid and the second starting material fluid in a state separated into an upper layer and an lower layer respectively, and a flow path forming member which forms plural minute flow paths for contacting the first starting material fluid in the upper layer with the second starting material fluid in the lower layer of the separation tank in a two-phase flow state; guiding the second starting material fluid separated as the lower layer in the separation tank upward toward the upper layer of the separation tank along each of the minute flow paths; and performing the chemical operation by contacting the first starting material fluid separated as the upper layer with the second starting material fluid which flows in the minute flow paths.

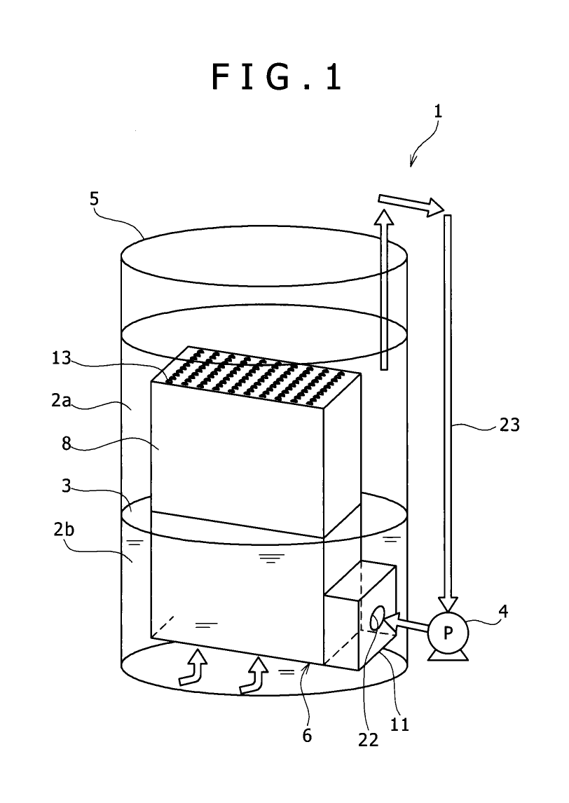

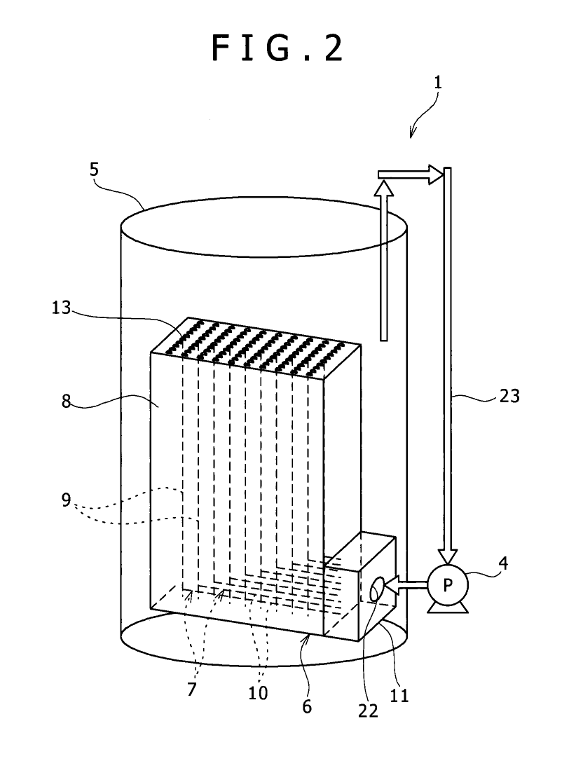

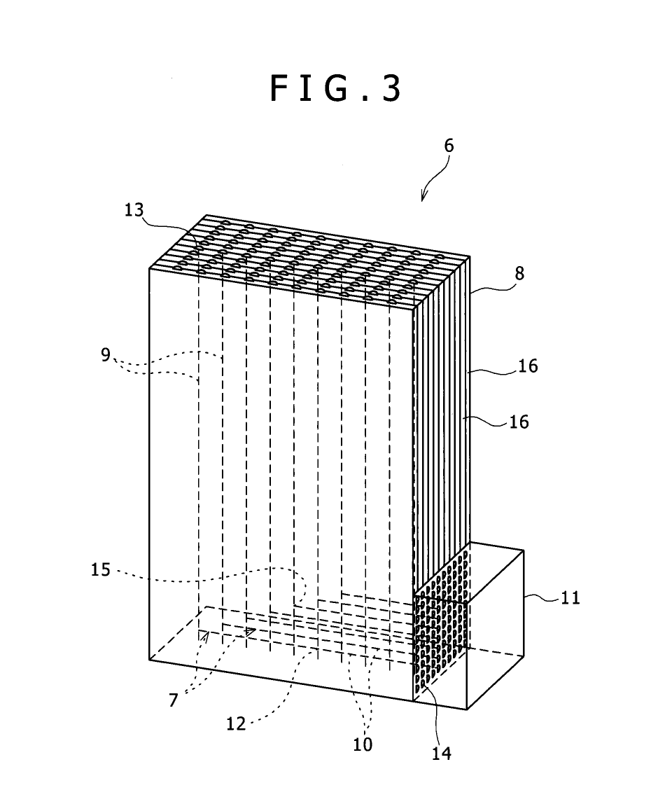

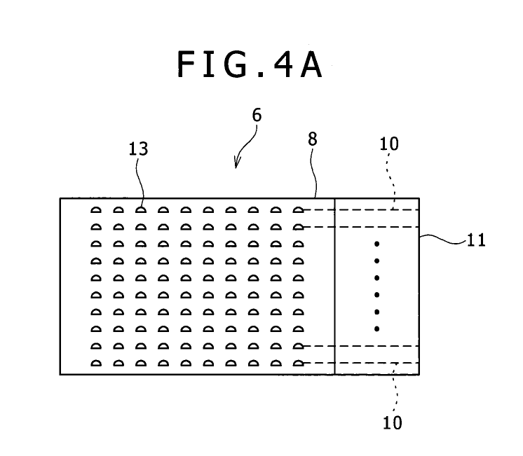

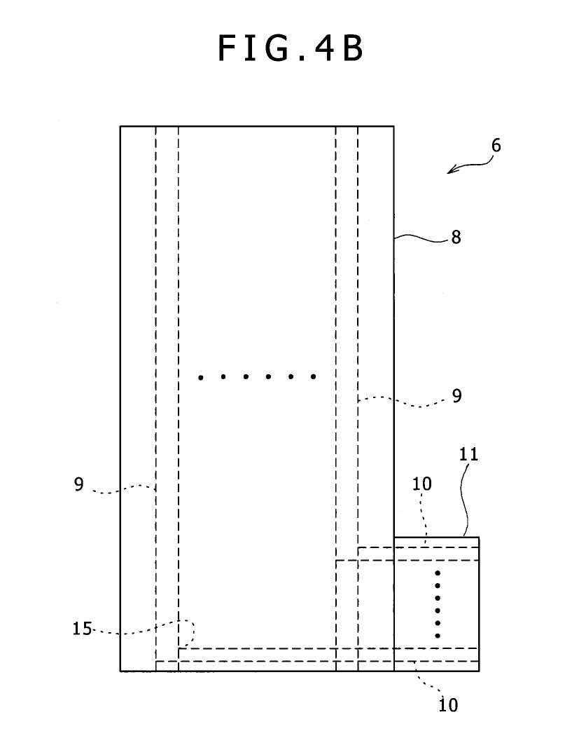

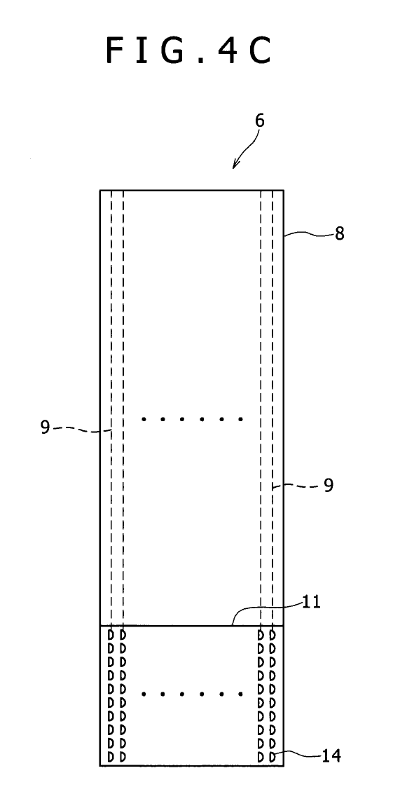

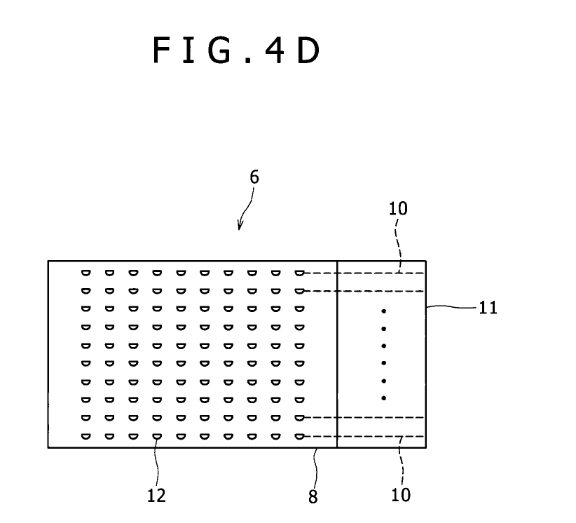

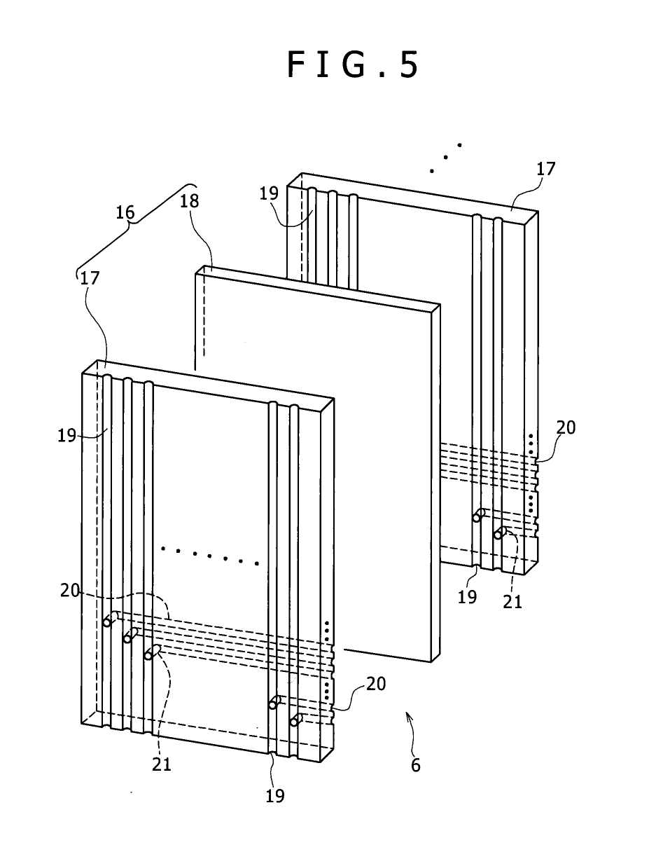

### BRIEF DESCRIPTION OF DRAWINGS

[FIG. 1] FIG. 1 is a perspective view of the processing device of a first embodiment of the present invention.

[FIG. 2] FIG. 2 is a perspective view showing flows of starting material fluids in the processing device of the first embodiment.

[FIG. 3] FIG. 3 is an enlarged view showing a flow path forming member in the processing device of the first embodiment.

[FIG. 4A] FIG. 4A is a plan view of the flow path forming member.

[FIG. 4B] FIG. 4B is a front view of the flow path forming member.

[FIG. 4C] FIG. 4C is a side view of the flow path forming member.

[FIG. 4D] FIG. 4D is a base plan of the flow path forming member.

[FIG. 5] FIG. 5 is a disassembled perspective view showing each single board member which constitutes the flow path forming member.

### DESCRIPTION OF EMBODIMENTS

Hereinbelow, an embodiment of the present invention is described on the basis of the figures.

FIG. 1 shows a processing device 1 of the present embodiment. This processing device 1 intends to contact together a first starting material fluid 2a and a second starting material fluid 2b which are not miscible with each other and differ in specific gravity, to perform a chemical operation such that a substance is transferred or reacted through an interface where the starting material fluids 2a, 2b contact with each other. This chemical operation includes operations such as extraction, separation or reaction.

For example, if an extraction is given as an example, the above mentioned chemical operation includes the followings. In other words, it includes operations such as contacting together a water-like heavy liquid (the second starting material fluid) and an oil-like light liquid (the first starting material fluid) which has a specific gravity smaller than the heavy liquid as the first and the second starting material fluids which are not miscible with each other, transferring a substance of object of extraction included in the light liquid (oil) positioned in the upper side of an interface to the heavy liquid (water) positioned in the lower side of the interface, and extracting the water in which the substance of the object of extraction is dissolved. A device to perform such operations is generally called as “liquid-liquid extraction device”. The processing device 1 may be applied not only to such liquid-liquid extraction device, but also to a liquid-liquid reaction device which carries out a chemical reaction such as a chemical synthesis on a liquid-liquid interface. In the following explanation, the processing device 1 is explained on the basis of an extraction device which carries out an extraction by a liquid-liquid extraction method as an example.

As shown in FIG. 1 and FIG. 2, the extraction device which is the processing device 1 of the first embodiment comprises a separation tank 5, a flow path forming member 6 and a pump 4. The separation tank 5 accommodates the first and the second starting material fluids 2a, 2b in a state separated into an upper layer and a lower layer respectively. The flow path forming member 6 is accommodated inside the separation tank 5 with being immersed in the first and the second starting material fluids 2a, 2b, and brings the first and the second starting material fluids 2a, 2b into contact with each other in the flow path forming member 6 to allow the extraction.

Specifically, the flow path forming member 6 forms plural minute flow paths 7 thereinside. These minute flow paths 7 are formed so as to allow taking in the first starting material fluid 2a of the upper layer of the separation tank 5 and the second starting material fluid 2b of the lower layer of the separation tank 5, contacting the taken first and second starting material fluids 2a, 2b each other in the minute flow paths 7, transferring a substance of object of extraction from one starting material fluid to the other starting material fluid, and returning the starting material fluids after the transfer of the substance to separation tank 5 in a mixed state.

Used as the first and the second starting material fluids 2a, 2b are two kinds of fluids which are not miscible with each other, namely, fluids which are not compatible with each other, and differ in specific gravity, such as an organic solvent and water, for example. Such starting material fluids 2a, 2b are capable of being separated from each other, such that each becomes single substances again after the extraction. Therefore, it becomes possible to easily extract a substance of object of the extraction in a state that the substance is dissolved in the starting material fluid.

To give a specific example, it is possible to use, as the first and the second starting material fluids 2a, 2b, a non-polar solution such as dodecane comprising a water-soluble organic compound such as phenol dissolved therein, and a polar solution such as water. These first and second starting material fluids 2a, 2b are not miscible with each other, and the non-polar solution having a small specific gravity rises up to the upper side of the separation tank 5 as the light liquid and the polar solution having a large specific gravity sinks down to the lower side of the separation tank 5 as the heavy liquid. Accordingly, it becomes possible to easily perform an extraction operation between liquid-liquid.

The fluids used as the first and the second starting material fluids are not limited to liquids. For example, it is also possible to select a gas and a liquid as the first and the second starting material fluids 2a, 2b respectively, if a lid or the like is provided on the separation tank 5 to secure airtightness inside the separation tank 5.

The separation tank 5 is an upwardly opened bottomed cylindrical container which is capable of housing the starting material fluids 2a, 2b inside. Specifically, when inside the separation tank 5 is charged with the first and the second starting material fluids 2a, 2b, a heavy liquid which is the second starting material fluid 2b sinks down to the lower side of the separation tank 5 and a light liquid which is the first starting material fluid 2a rises up to the upper side of the separation tank 5. Thus, the separation tank 5 is capable of accommodating the light liquid and the heavy liquid in a state separated into the upper layer and the lower layer respectively.

Between the light liquid and the heavy liquid, a boundary surface 3 which is a liquid-liquid interface is formed. The separation tank 5 houses the heavy liquid and the light liquid with accommodating the flow path forming member 6 in a position where the boundary surface 3 horizontally traverses a part midway through the flow path forming member 6 in an up/down direction. Thus, inside the separation tank 5, the upper end of the flow path forming member 6 is positioned above the boundary surface 3, and the lower end of the flow path forming member 6 is positioned below the boundary surface 3.

Each of the plural minute flow paths 7 formed by the flow path forming member 6 includes first flow paths 9 and second flow paths 10. The first flow paths 9 intake the second starting material fluid 2b of the lower layer from the lower side of the flow path forming member 6 and guide the fluid to the upper side of the flow path forming member 6. The second flow paths 10 takes in the first starting material fluid 2a of the upper layer and introduce the fluid into the first flow paths 9.

Next, the flow path forming member 6 is described in detail.

As described above, the flow path forming member 6 intends to extract a substance of object of extraction by contacting the heavy liquid and the light liquid, and comprises a board-like shaped main body 8 which extends along the up/down direction, namely, which is long in the up/down direction, and a flow separation header 11 provided on the side surface of the main body 8, as shown in FIG. 3 and FIG. 4A to FIG. 4D.

The main body 8 is formed with a metal, a synthetic resin or a ceramic having a corrosion resistance or a heat resistance against the first and second starting material fluids 2a, 2b, and has an appearance of a thick board with a relatively large thickness in the board thickness direction. Inside the main body 8, the plural minute flow paths 7 are formed to allow an extraction by contacting the heavy liquid and the light liquid inside each of the minute flow paths 7. Specifically, the first flow path 9 of each of the minute flow paths 7 penetrates through the main body 8 of the flow path forming member 6 in the up/down direction, and the second flow path 10 extends in the horizontal direction in the main body 8.

As shown by broken lines in FIG. 2 and FIG. 3, a lower end of each of the first flow paths 9 constitutes a first intake port 12, and this first intake port 12 opens in a semicircular shape on the bottom surface of the main body 8. The first flow path 9 is capable of taking in the second starting material fluid 2b of the lower layer which is the heavy liquid from the first intake port 12 and guiding the liquid upward with passing the liquid inside the main body 8. The first flow path 9 extends further upward beyond the above described boundary surface 3. The upper end of the first flow path 9 constitutes an outlet port 13 which opens in a semicircular shape similarly to the first intake port 12, on the upper surface of the main body 8, and it is possible to introduce the heavy liquid which has been guided to the upper side of the flow path forming member 6 out to the upper side of the separation tank 5 through the outlet port 13.

The second flow path 10 connects to the first flow path 9 so as to join the light liquid taken in from the upper side of the separation tank 5 in the heavy liquid which flows in the first flow path 9. Specifically, the outer end of the individual second flow path 10 each constitutes a second intake port 14, and each second intake port 14 opens in a region of the side surface of the main body 8 on which the flow separation header 11 is provided. That is, each of the second flow paths 10 extends in the horizontal direction in the main body 8, from each of the second intake ports 14. The second intake port 14 opens in a semicircular shape similarly to the first intake port 12, and opens toward the inside of the flow separation header 11, to thereby allow the starting material fluid 2a of the upper layer which is a light liquid introduced inside the flow separation header 11 to be taken in into the second flow paths 10. The inner end of the second flow path 10 constitutes a merging port 15. This merging port 15 opens on a portion midway through the first flow path 9 in the up/down direction, more precisely, on a part above the above described first intake port 12 and below the boundary surface 3. This merging port 15 allows the light liquid taken in into the second flow path 10 to join the heavy liquid which flows in the first flow path 9 through the merging port 15.

The plural minute flow paths 7 which comprise each of the above described first flow paths 9 and the second flow paths 10 can be formed inside the flow path forming member 6, for example, by the following method.

As shown in FIG. 5, plural single board members 16 are prepared, the single board members 16 having a rectangle shape in which the height which is the dimension in the up/down direction is larger than the width which is the dimension in the horizontal direction. These plural single board members 16 are then laminated in the board thickness direction to form the flow path forming member 6. It is preferred that the plural single board members 16 comprise first single board members 17 having a first thickness and second single board members 18 having a second thickness which is smaller than the first thickness, and the flow path forming member 6 is formed with plural first single board members 17 and plural second single board members 18 alternately laminated in the board thickness direction in such a manner that a second single board member 18 adjoins a side of a first single board member 17, and another first single board member 17 further adjoins a side of this second single board member 18.

Each of the first single board members 17 has a front surface (surface) and a back surface, and on the front surface of the surfaces, plural lines of first grooves 19 are formed. These first grooves 19, each constituting the first flow path 9, extend along the up/down direction in parallel to each other. Between the first grooves 19 which are adjacent to one another, predetermined spaces are provided in the horizontal direction. Each of the first grooves 19 has a semicircular cross section, and is recessed concavely on the front surface. A heavy liquid which is the second starting material fluid 2b is guided in the up/down direction in such a manner as being passed through the recessed portion.

On the back surface of the first single board member 17, plural lines of second grooves 20 are formed. These second grooves 20 each constitute each of the second flow paths 10, and extend along the horizontal direction. Each of the second grooves 20 is perpendicular to the first grooves 19. Between the second grooves 20 which are adjacent to one another, predetermined spaces are provided in the up/down direction. Each of the second grooves 20 also has a semicircular cross section, and is recessed concavely on the back surface. A light liquid which is the first starting material fluid 2a is guided along the horizontal direction in such a manner as being passed through the recessed portion.

The second flow paths 10 each constituted by the second groove 20 have lengths different from one another, and each connected to the first flow path 9 corresponding to each of the second flow paths 10, at positions different from one another in the up/down direction and in the horizontal direction. In the example shown in FIG. 5, the grooves positioned in the lower side of the second grooves 20 each constituting the second flow paths 10 are shorter than the grooves positioned in the upper side. That is, the second grooves 20 which are positioned relatively lower side guide the starting material fluid 2a to the first flow paths 9 which are positioned relatively near from the flow separation header 11, and the second grooves 20 which are positioned relatively upper side guide the starting material fluid 2a to the first flow paths 9 which are positioned relatively far from the flow separation header 11. As for the level of the each second groove 20, it is set such that, in a state that the inside of the separation tank 5 with the flow path forming member 6 installed inside is charged with the first starting material fluid 2a (light liquid) and the second starting material fluid 2b (heavy liquid), the uppermost second groove 20 is always positioned in the side below the boundary surface 3 of the second starting material fluid 2b and the first starting material fluid 2a in the separation tank 5. The relationship between the level position and the length of the each second flow path 10 may be opposite to the relationship shown in FIG. 5. In the example shown in FIG. 2-FIG. 4, contrarily to the example shown in FIG. 5, those positioned in the upper side of the second flow paths 10 are shorter than those positioned in the lower side. That is, the second flow paths 10 which are positioned relatively upper side guide the starting material fluid 2a to the first flow paths 9 which are positioned relatively near from the flow separation header 11, and the second flow paths 10 which are positioned relatively lower side guide the starting material fluid 2a to the first flow paths 9 which are positioned relatively far from the flow separation header 11.

Inside the first single board member 17, plural through-holes 21 are formed, each through-hole connecting a first groove 19 in the front surface and a second groove 20 in the back surface. These through-holes 21 allow the starting material fluid 2a which flow through the second grooves 20 to join the first grooves 19 through the through-holes 21. That is, the openings of the through holes 21 in the first grooves 19 correspond to “the merging ports 15 of the second flow paths 10 to the first flow paths 9” described above.

Meanwhile, each of the second single board members 18 is a flat plate with a front surface and a back surface, neither of the surfaces having a groove formed thereon. These second single board members 18 are laminated on the front surfaces or the back surfaces of the first single board members 17 to thereby close the first grooves 19 or the second grooves 20 formed on the first single board members 17 in the board thickness direction, to form the above described first flow paths 9 or the second flow paths 10. Specifically, the second single board member 18 closes the first grooves 19 in the board thickness direction by being laminated on the front surface of the first single board member 17, to thereby allow the first grooves 19 to be utilized as the first flow paths 9. Similarly, the second single board member 18 closes the second grooves 20 in the board thickness direction by being laminated on the back surface of the first single board member 17, to thereby allow the second grooves 20 to be utilized as the second flow paths 10. Accordingly, if the single board members 17 and the second single board members 18 are alternately laminated in the board thickness direction, it becomes possible to easily form the flow path forming member 6 in which the bonding portions of the first single board members 17 and the second single board members 18 each have the plural first flow paths 9 and the second flow paths 10 formed thereon.

The flow separation header 11 is a box-shaped member having a height which is a dimension in the up/down direction smaller than that of the main body 8 above described, and is installed so as to be along the side surface of the main body 8. Specifically, the flow separation header 11 is provided in the lower part of the side surface of the main body 8, such that the position of bottom surface level of the flow separation header 11 matches the position of bottom surface level of the main body 8. The flow separation header 11 may be hollow and capable of accommodating a light liquid which has been taken in by the pump 4, as will be described later.

The side of the flow separation header 11 which faces the main body 8 opens wide and has no wall. The plural second intake ports 14 described above are formed on the side surface of the main body 8 within a region that corresponds to the opened side surface of the flow separation header 11. Accordingly, the first starting material fluid 2a which is the light liquid temporarily housed in the flow separation header 11 is approximately equally distributed to each of the first flow paths 9 which communicate with the second intake ports 14, from the flow separation header 11 through the plural second intake ports 14.

Among side surfaces of the flow separation header 11, on a side surface opposite to the side opening as described above, sandwiching the center of the flow separation header 11, a supply port 22 for taking in the light liquid taken in by use of the pump 4 into the flow separation header 11 is formed.

The pump 4 draws in the first starting material fluid 2a which is the light liquid housed in the upper side of the separation tank 5, and discharges the light liquid into the flow separation header 11 described above. Namely, the pump 4 supplies the light liquid to the second flow paths 10. Specifically, this pump 4 is installed to a suction pipe line 23 which connects a part in the upper side of the separation tank 5 and the supply port 22 of the flow separation header 11 with each other. This suction pipe line 23 extends from the supply port 22 of the flow separation header 11 to the vicinity of the upper end of the separation tank 5, passing the outside of the separation tank 5, and is bent downward in inverted U-shape in the vicinity of the upper end of the separation tank 5. A tip of this bent side is positioned inside the separation tank 5, and immersed in the starting material fluid 2a (the light liquid) of the upper side. The pump 4 is provided midway the path of the suction pipe line 23, and driven so as to draw in the light liquid which is the first starting material fluid 2a of the upper side into the suction pipe line 23, and pressure-feed the light liquid to the flow separation header 11. By supplying the first starting material fluid 2a of the upper side to the flow separation header 11 by using the pump 4 in such a manner, the first starting material fluid 2a is allowed to join the second starting material fluid 2b of the lower side which flows through the first flow paths 9.

Next, a method of performing an extraction operation by using the processing device 1 which is the above described extraction device, in other words, an extraction method corresponding to a processing method of the present invention will be described.

Described here as an example is a case in which water is housed as the heavy liquid in the lower side of the separation tank 5; dodecane which is an organic solvent is housed as the light liquid in the upper side of the separation tank 5; and an water-soluble phenol included in dodecane as the light liquid is extracted by being transferred to the heavy liquid.

As shown in FIG. 1, in the first place, the flow path forming member 6 is accommodated inside the separation tank 5. This flow path forming member 6 is disposed inside the separation tank 5 such that the first flow paths 9 are directed to the up/down direction, the first intake ports 12 thereof are positioned in the lower side of the separation tank 5, and the outlet ports 13 are positioned in the upper side of the separation tank 5.

Into the inside of the separation tank 5 which thus accommodates the flow path forming member 6, dodecane as the light liquid and water as the heavy liquid are poured. Then, dodecane having a small specific gravity rises to the upper side of the separation tank 5, and the water having a large specific gravity sinks to the lower side of the separation tank 5. Accordingly, dodecane and the water are housed in a state separated into an upper layer and a lower layer respectively inside the separation tank 5. Between dodecane and the water thus separated into two layers, a boundary surface 3 is formed which partitions the first and the second starting material fluids 2a, 2b which are dodecane and the water. Dodecane and the water which are the light liquid and the heavy liquid are poured inside the separation tank 5, such that the level of the boundary surface 3 is positioned above the merging ports 15 of the flow path forming member 6 described above.

In this condition, the pump 4 described above is driven. This pump 4 draws in dodecane in the upper side into the suction pipe line 23, and sends it to the flow separation header 11 through the suction pipe line 23. In the flow separation header 11, dodecane is distributed to each of the second flow paths 10, and joined to the water which flows through the first flow paths 9, through the individual merging port 15. In such a manner, dodecane as the light liquid and the water as the heavy liquid contact with each other in a two-phase flow state in each of the minute flow paths 7.

Specifically, in the first flow paths 9 above the merging ports 15, dodecane as the light liquid and the water as the heavy liquid are each separated into droplets of small volumes, and move upward in the pipe lines with the droplets of dodecane and the droplets of the water being alternately arranged in the up/down direction. During this upward movement, phenol moves from dodecane as the light liquid to the water as the heavy liquid. In such a manner, an extraction of phenol to the water is performed.

In this state where the liquids are separated into droplets, a large buoyancy acts on dodecane as the light liquid, due to a density difference between the inside and the outside of the first flow paths 9. Therefore, dodecane as the light liquid vigorously rise in the first flow paths 9, and according to this rise of the light liquid, the water as the heavy liquid having a large specific gravity also becomes easy to rise. Thus, in the state where the liquids are separated into droplets, dodecane and the water, namely, the first and the second starting material fluids 2a, 2b pass through the minute flow paths 7 in a short time without being stagnated in the minute flow paths 7. This allows an extraction operation to be efficiently proceeded.

For example, it becomes possible to further increase the rising speed of the starting material fluids 2a, 2b in the droplet state in the minute flow paths 7, if bubbles of air or an inert gas are intentionally generated inside the first flow paths 9 or the second flow paths 10. Thus, it is preferred to provide, for example, a member for generating bubbles of air or an inert gas (such as bubble generator) in the first flow paths 9 or the second flow paths 10.

If a flow path diameter of the first flow path 9 below the merging port 15 is large, there is a possibility that the light liquid of the second flow path 10 which has been joined from the merging port 15 flows downward in the reverse direction. In such a case, it is preferred to provide the first flow path 9 below the merging ports 15 with a reverse-flow prevention member which prevents the first starting material fluid 2a of the upper layer from flowing downward in the reverse direction. This reverse-flow prevention member may be a check valve, or those which prevent the flow in the reverse direction by utilizing the shape of the first flow paths 9. It is also possible to prevent the flow in the reverse direction of the starting material fluid 2a, for example, by forming a small diameter part having a small flow path diameter compared to a flow path diameter of a part above the merging ports 15, on a part of the first flow paths 9 below the merging ports 15,

If the light liquid and the heavy liquid are contacted with each other with being made rise in the droplet state along the first flow paths 9 in the manner described above, it is possible to efficiently transfer phenol contained in the light liquid to the heavy liquid. Furthermore, dodecane as the light liquid after the phenol has been removed is discharged from the outlet ports 13 of the first flow paths 9 to the upper side of the separation tank 5, to be returned to the liquid layer of dodecane positioned in the upper side of the separation tank 5. Therefore, if the processing is performed with continuously recycling the light liquid in the minute flow paths 7 by use of pump 4, it becomes possible to surely remove phenol from dodecane in a short time.

Meanwhile, the water which has received the phenol in the minute flow paths 7 is discharged from the outlet ports 13 of the first flow paths 9 to the upper side of the separation tank 5. However, due to its large specific gravity compared to dodecane, the water sinks down below the liquid layer of dodecane and returns to the liquid layer of water in the lower side of the first and the second starting material fluids 2a, 2b which are dodecane and the water separated into the upper layer and the lower layer respectively. Therefore, if the heavy liquid is continuously recycled in the minute flow paths 7 by use of the pump 4, it becomes possible to extract phenol of object of extraction in a state dissolved in water, by transferring the phenol from dodecane in the minute flow paths 7.

For example, in an extraction device of mixer-settler type which mixes the entire first and second starting material fluids 2a, 2b by using a stirring blade and the like, when the stirring is made strong, the fractionation of the starting material fluids 2a, 2b together are progressed excessively, and as a result, it is not possible to enhance efficiency of chemical operations such as extraction. However, in the extraction device using the flow path forming member 6 described above (the processing device 1), it is possible that a part of the first and of the second starting material fluids 2a, 2b are each introduced into the minute flow paths 7 to perform an operations such as extraction within the minute flow paths 7. In other words, it is possible to perform the extraction with keeping most of the starting material fluids 2a, 2b in a separated state as single substances, without need of mixing the entire starting material fluids 2a and 2b. Therefore, it is possible to efficiently perform chemical operations such as extraction, separation or reaction in an extremely short time, without need of separating operation which is performed in a settler tank or the like in conventional devices, namely, without need of a great deal of time for the operation to separate the starting material fluids once mixed with each other into the single starting material fluids again.

The embodiments disclosed herein are to be considered in all respects as illustrative and not restrictive. In particular, any matter which is not explicitly disclosed in the embodiments disclosed herein, for example, driving conditions, operating conditions, any kinds of parameters, dimensions, weight, volume of the structure or the like does not deviate from the range within which those skilled in the art usually perform, and the values employed herein are those which can be easily expected by those skilled in the art.

### INDUSTRIAL APPLICABILITY

As disclosed above, the present invention provides a processing device and a processing method which are capable of enhancing an efficiency in a case of performing a chemical operation such as extraction, separation or reaction, by transferring a substance through a boundary surface where a first and a second starting material fluids which differ in specific gravity contact with each other.

The present invention provides a processing device for performing a chemical operation in a part where a first starting material fluid and a second starting material fluid contact with each other, by contacting together the first starting material fluid and the second starting material fluid which differ in specific gravity. This processing device comprises a separation tank which accommodates the first starting material fluid and the second starting material fluid in a state separated into an upper layer and an lower layer respectively, and a flow path forming member that is disposed inside the separation tank and forms plural minute flow paths for contacting the first starting material fluid in the upper layer with the second starting material fluid in the lower layer of the separation tank. Each of the plural minute flow paths comprises a first flow path that penetrates the flow path forming member in the up/down direction and guides the second starting material fluid in the lower side of the flow path forming member to the upper side of the flow path forming member; and a second flow path that connects to the first flow path so as to take in the first starting material fluid of the upper layer and introduce the fluid to inside the first flow path.

The present invention also provides a processing method for performing a chemical process in a part where a first starting material fluid and a second starting material fluid contact with each other, by contacting together the first starting material fluid and the second starting material fluid which differ in specific gravity. This processing method comprises preparing a separation tank which accommodates the first starting material fluid and the second starting material fluid in an state separated into upper/lower, and a flow path forming member which comprises plural minute flow paths for contacting the first starting material fluid of the upper layer with the second starting material fluid of the lower layer of the separation tank in a two-phase flow state; guiding the second starting material fluid separated as the lower layer in the separation tank upwards toward the upper layer of the separation tank along each of the minute flow paths; and performing the chemical operation by contacting the first starting material fluid separated as the upper layer with the second starting material fluid in the minute flow path.

According to the processing device and the processing method, it is possible to efficiently perform chemical operations such as extraction, separation or reaction, without need of taking time for separating the mixture of the starting material fluids once fractionated, into the single starting material fluids again.

The processing device is preferably further provided with a pump for sending the first starting material fluid of the upper layer of the separation tank to the second flow path. This pump is capable of efficiently joining the first starting material fluid to the second starting material fluid which flows through the first flow path.

The flow path forming member preferably comprises a plural single board members having a front surface and a back surface which are laminated with each other in the board thickness direction, and it is preferred that at least a part of these single board members have the minute flow paths formed on at least one surface of the front surface and the back surface. The plural single board members are capable of constituting the flow path forming member which comprises the plural minute flow paths, by being laminated with each other, with a simple structure.

The flow path forming member preferably comprises a merging ports which is midway through the first flow paths in the up/down direction and allow the first starting material fluid to join from the second flow paths therethrough, and a reverse-flow prevention member which is in a part of the first flow path below the merging port and prevents the first starting material fluid of the upper layer from flowing downward in the reverse direction.

The flow path forming member is preferably disposed in the separation tank so as to guide the second starting material fluid of the lower layer taken in from the side below the boundary surface formed between the first starting material fluid in the upper layer and the second starting material fluid in the lower layer in the separation tank, to the side above the boundary surface through the first flow paths, and such that the part where the first flow paths and the second flow paths are connected with each other is positioned in the side below the boundary surface.

1. A processing device for performing a chemical operation in a part where a first and a second starting material fluids contact with each other, by contacting together the first and the second starting material fluids which differ in specific gravity, which comprises
a separation tank which accommodates said first and second starting material fluids in a state separated into an upper layer and a lower layer respectively,
a flow path forming member that is disposed inside said separation tank and forms plural minute flow paths for contacting said first starting material fluid in an upper layer with said second starting material fluid in a lower layer of the separation tank,
wherein each of said plural minute flow paths comprises a first flow path that penetrates said flow path forming member in an up/down direction and guides said second starting material fluid in a lower side of said flow path forming member to an upper side of the flow path forming member, and a second flow path that connects to said first flow path so as to take in said first starting material fluid of said upper layer and introduce the fluid into said first flow path.

2. The processing device according to claim 1 which is further provided with a pump for sending said first starting material fluid of the upper layer of said separation tank to said second flow path.

3. The processing device according to claim 1, wherein: said flow path forming member comprises plural single board members which comprise a front surface and a back surface and are laminated with one another in the board thickness direction; and said minute flow paths are formed on at least one surface of the front surface and the back surface of at least a part of the single board members of said plural single board members.

4. The processing device according to claim 1, wherein said flow path forming member comprises a merging port which is midway said first flow path in an up/down direction and allows said first starting material fluid to join from said second flow path therethrough, and a reverse-flow prevention member which is in a part of said first flow path below said merging port and prevents said starting material fluid of said upper layer from flowing downward in the reverse direction.

5. The processing device according to claim 1, wherein said flow path forming member is disposed in said separation tank such that said second starting material fluid of the lower layer taken in from the side below a boundary surface which is formed between said first starting material fluid in the upper layer and said second starting material fluid in the lower layer in said separation tank, is guide to the side above said boundary surface through said first flow path, and such that the part where said first flow path and said second flow path are connected with each other is positioned in the side below said boundary surface.

6. A processing method for performing a chemical process in a part where a first starting material fluid and a second starting material fluid contact with each other, by contacting together the first starting material fluid and the second starting material fluid which differ in specific gravity, which comprises
preparing a separation tank which accommodates said first starting material fluid and said second starting material fluid in a state separated into an upper layer and a lower layer respectively, and a flow path forming member which forms plural minute flow paths for contacting said first starting material fluid in the upper layer with said second starting material fluid in the lower layer of the separation tank in a two-phase flow state;
guiding said second starting material fluid separated as said lower layer in said separation tank, upwards toward the upper layer of said separation tank along each of said minute flow paths; and
performing said chemical operation by contacting said first starting material fluid separated as said upper layer with said second starting material fluid which flows in the minute flow paths.
